(19) United States
(12) Patent Application Publication
(10) Pub. No.: US 2017/0061935 A1
(43) Pub. Date: Mar. 2, 2017

(54) ADAPTIVE MESSAGE DISPLAY DURATION

(71) Applicant: SAP SE, Walldorf (DE)

(72) Inventor: Bernard Rummel, Weinheim (DE)

(21) Appl. No.: 14/841,172

(22) Filed: Aug. 31, 2015

(51) Int. Cl. G09G 5/36; G06F 3/01; G06F 3/0481

(52) U.S. Cl. CPC G09G 5/363; G06F 3/0481; G06F 3/013; G09G 2380/14; G09G 2354/00; G09G 2340/12; G09G 2340/14

(57) ABSTRACT

A system includes determination to display a message to a user, determination of a length of the message, determination of a reading speed associated with the user, determination of a finite duration based on the length of the message and the reading speed, and display of the message to the user on the display device for the finite duration.

### BACKGROUND

Software applications provide graphical user interfaces (GUIs) to facilitate interaction with users. A software application may utilize a GUI to display information to a user and to receive commands from a user. For example, a software application may detect user manipulation of controls presented by the GUI and identify user commands based on the manipulation.

Occasionally, in response to a particular event, a software application may display a message to a user. Such messages may be displayed for a predetermined length of time and then disappear automatically. A user may be unable to read the entire message before it disappears. Alternatively, a user may read the message and then be forced to wait until the message disappears. This waiting may negatively impact the user's workflow, particularly since these messages are typically superimposed upon a central area of a GUI.

### BRIEF DESCRIPTION OF THE DRAWINGS

FIG. 1 is a block diagram of a system architecture according to some embodiments.

FIG. 2 is a block diagram of a system architecture according to some embodiments.

FIG. 3 is a flow diagram of a process according to some embodiments.

FIG. 4 is an outward view of a user interface according to some embodiments.

FIG. 5 is a block diagram illustrating data sources according to some embodiments.

FIG. 6 is a tabular representation of a reading speed table according to some embodiments.

FIG. 7 is an outward view of a user interface including a temporary message according to some embodiments.

FIG. 8 is a flow diagram of a process according to some embodiments.

FIG. 9 is an outward view of a user interface including a temporary message according to some embodiments.

FIG. 10 is an outward view of a user interface including a temporary message according to some embodiments.

FIG. 11 is a block diagram of an apparatus according to some embodiments.

### DETAILED DESCRIPTION

The following description is provided to enable any person in the art to make and use the described embodiments. Various modifications, however, will remain readily apparent to those in the art.

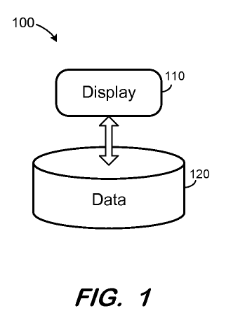

FIG. 1 is a block diagram of the architecture of a generic system according to some embodiments. System 100 includes display 110 and data 120. Generally, and according to some embodiments, system 100 may comprise a desktop computer, a laptop computer, a tablet computer, a smartphone or any other computing system that is or becomes known. System 100 operates to display a message to a user via display 110 for a duration which is based on a length of the message and based on data stored in data 120 indicative of a reading speed of the user.

Display 110 may comprise any type of system capable of presenting images to a user, including but not limited to a computing system which comprises a display device, a processor and process steps which are executable by the processor to cause the computing device to display images on the display device.

Data 120 may comprise data stored in any one or more formats and in any one or more types of storage devices. Data 120 and display 110 may be elements of a same computing system or may be located remote from one another. As will be described in detail below, data 120 may be used to determine a duration for which a message is displayed on display 110 according to some embodiments. Data 120 may include data associated with a reading speed of one or more users, and/or associated with messages to be displayed by display 110.

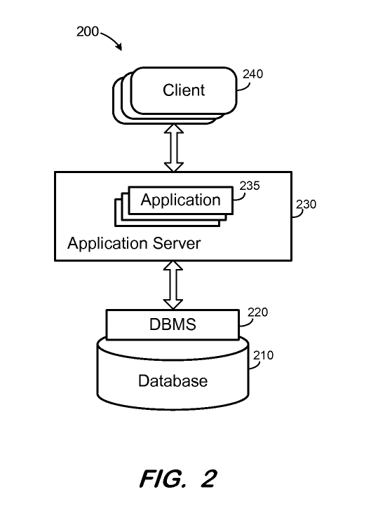

FIG. 2 is a block diagram of database architecture 200 according to some embodiments. Embodiments are not limited to architecture 200 or to a database architecture.

Architecture 200 includes database 210, database management system (DBMS) 220, application server 230, applications 235 and clients 240. Generally, applications 235 executing within application server 230 receive queries from clients 240 and provides results to clients 240 based on data of database 210.

Application server 230 executes and provides services to applications 235. Applications 235 may comprise server-side executable program code (e.g., compiled code, scripts, etc.) which provide functionality to clients 240 by providing user interfaces to clients 240, receiving requests from clients 240, retrieving data from database 210 based on the requests, processing the data received from database 210, and providing the processed data to clients 240. Applications 235 may be made available for execution by application server 230 via registration and/or other procedures which are known in the art.

Application server 230 provides any suitable interfaces through which clients 240 may communicate with applications 235 executing on application server 230. For example, application server 230 may include a HyperText Transfer Protocol (HTTP) interface supporting a transient request/response protocol over Transmission Control Protocol (TCP), a WebSocket interface supporting non-transient full-duplex communications between application server 230 and any clients 240 which implement the WebSocket protocol over a single TCP connection, and/or an Open Data Protocol (OData) interface.

One or more applications 235 executing on server 230 may communicate with DBMS 220 using database management interfaces such as, but not limited to, Open Database Connectivity (ODBC) and Java Database Connectivity (JDBC) interfaces. These types of applications 235 may use Structured Query Language (SQL) to manage and query data stored in database 210.

DBMS 220 serves requests to retrieve and/or modify data of database 210, and also performs administrative and management functions. Such functions may include snapshot and backup management, indexing, optimization, garbage collection, and/or any other database functions that are or become known. DBMS 220 may also provide application logic, such as database procedures and/or calculations, according to some embodiments. This application logic may comprise scripts, functional libraries and/or compiled program code.

Application server 230 may be separated from or closely integrated with DBMS 220. A closely-integrated application server 230 may enable execution of server applications 235 completely on the database platform, without the need for an additional application server. For example, according to some embodiments, application server 230 provides a comprehensive set of embedded services which provide end-to-end support for Web-based applications. The services may include a lightweight web server, configurable support for OData, server-side JavaScript execution and access to SQL and SQLScript.

Database 210 may comprise any query-responsive data source or sources that are or become known, including but not limited to a structured-query language (SQL) relational database management system. Database 210 may comprise a relational database, a multi-dimensional database, an eXtendable Markup Language (XML) document, or any other data storage system storing structured and/or unstructured data. The data of database 210 may be distributed among several relational databases, dimensional databases, and/or other data sources. Embodiments are not limited to any number or types of data sources.

In some embodiments, the data of database 210 may comprise one or more of conventional tabular data, row-based data, column-based data, and object-based data. Moreover, the data may be indexed and/or selectively replicated in an index to allow fast searching and retrieval thereof Database 210 may support multi-tenancy to separately support multiple unrelated clients by providing multiple logical database systems which are programmatically isolated from one another.

Database 210 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

Each of clients 240 may comprise one or more devices executing program code of a software application for presenting user interfaces to allow interaction with application server 230. The user interfaces may comprise user interfaces suited for reporting, data analysis, data modelling, and/or any other functions based on the data of database 210.

Presentation of a user interface as described herein may comprise any degree or type of rendering, depending on the type of user interface code generated by application server 230. For example, a client 240 may execute a Web Browser to request and receive a Web page (e.g., in HTML format) from application server 230 via HTTP, HTTPS, and/or WebSocket, and may render and present the Web page according to known protocols. Embodiments are not limited to a Web browser, as one or more of clients 240 may also or alternatively present user interfaces by executing a standalone executable file (e.g., an .exe file) or code (e.g., a JAVA applet, Flash code) within a virtual machine.

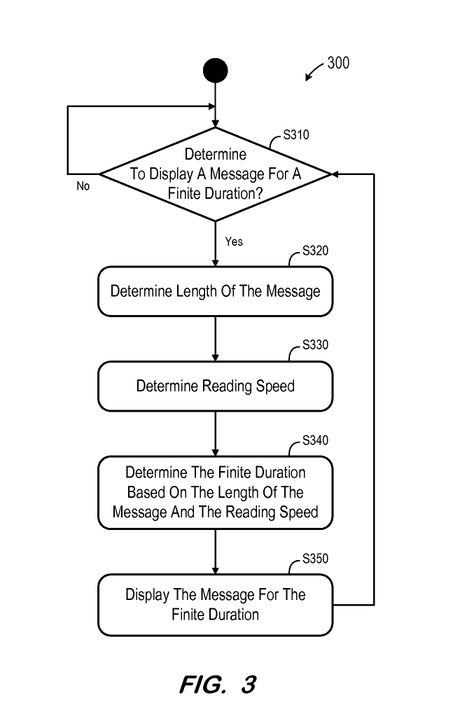

FIG. 3 comprises a flow diagram of process 300 according to some embodiments. Process 300 may facilitate the display of messages according to some embodiments.

In some embodiments, various hardware elements of architecture 100 and/or architecture 200 (e.g., one or more processors) execute program code to perform process 300. Process 300 and all other processes mentioned herein may be embodied in processor-executable program code read from one or more of non-transitory computer-readable media, such as a floppy disk, a disk-based or solid-state hard drive, CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S310, it is determined whether or not to display a message for a finite duration. As described in the Background, some software applications utilize messages which are displayed and then removed without requiring user intervention (e.g., selecting a “Close” button or control). These messages may consist of alerts, confirmations, reminders, and/or any information deemed suitable for display in this manner. Flow therefore cycles at S310 until it is determined that such a message is to be displayed. During such cycling, the application continues to execute as intended to present various user interfaces to a user.

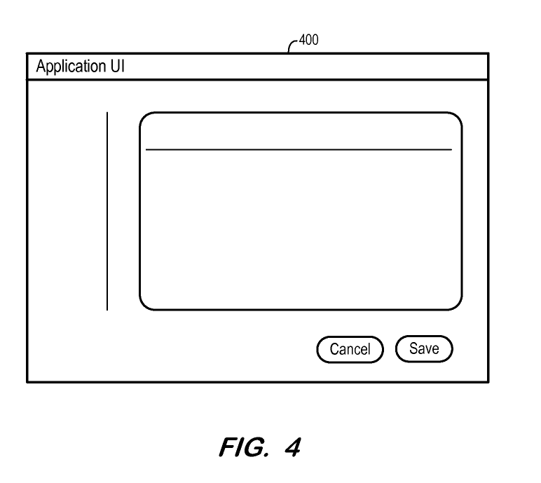

FIG. 4 is an outward view of interface 400 according to some embodiments. Interface 400 may be presented on any type of display apparatus (e.g., desktop monitor, smartphone display, tablet display) provided by any type of client device (e.g., desktop system, smartphone, tablet computer). The application which is executed to provide interface 400 may comprise a Web Browser, a standalone application, or any other application. Embodiments are not limited to interface 400, and may include user interfaces having any particular type, format or function.

Flow proceeds to S320 once it is determined at S310 to display a message for a finite duration. A length of the message to be displayed is determined at S320. The length may be determined in terms of number of characters, number of words, number of syllables, display distance spanned, and/or any other suitable metric. The message may be hard-coded into the software application and/or retrieved from a data store such as data 120 or database 210.

Next, at S330, a reading speed is determined. The reading speed may be a reading speed associated with the user to whom the message will be displayed. The reading speed may be denoted as a length per unit of time, where “length” is defined in any manner as described above. The reading speed may be determined based on one or more sources, and may be specific to the user to whom the message will be displayed or specific to a group (e.g., a demographic group) to which the user belongs.

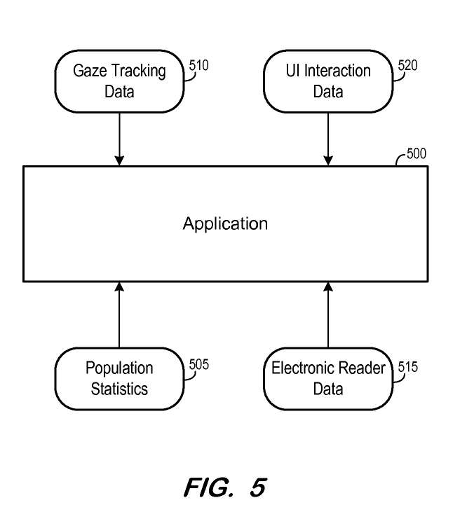

FIG. 5 is a diagram illustrating sources of reading speed data according to some embodiments. As shown, application 500 implementing an embodiment may receive population statistics 505 indicating average reading speeds for various population groups (e.g., by age, education, etc.). Application 500 may also or alternatively receive user-specific reading speed data such as gaze tracking data 510, electronic reader data 515, and UI interaction data 520.

Gaze tracking data 510 may be received from known devices which track a user's eye movements and generate corresponding data. A user's reading speed may be estimated from the eye movements. Gaze tracking data 510 may be provided by any one or more devices, and such one or more devices need not be coupled to the display on which the message is to be displayed.

Similarly, electronic reader data 515 may be provided by a device which is otherwise separate from the devices and systems implementing process 300. In this regard, known electronic readers may determine estimated reading speeds based on the frequency with which a user “turns” pages while reading on such a device.

UI interaction data 520 may include information describing prior user interactions with a user interface. These interactions may be indicative of the user's reading speed. For example, the speed with which a user closes a displayed window may be indicative of the speed with which the user has read a message displayed by the window. Additionally, UI interaction data 520 may also include gaze tracking data as described above, in a case that the user's gaze is tracked while reading text displayed within the user interface. As will be described in detail below, user interaction data 520 may include data describing a user's interaction with a message that is displayed according to embodiments described herein, thereby providing a feedback loop controlling the duration of message display.

The “user-specific” reading speed data 510, 515 and 520 need not be specific to the user to whom the current message is to be displayed. For example, application 500 may use any or all of reading speed data 510, 515 and 520 to generate aggregate reading speed data for a particular segment of the user population.

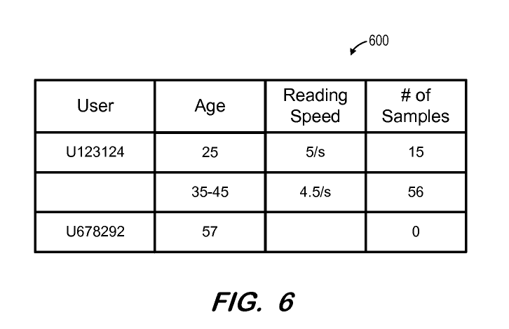

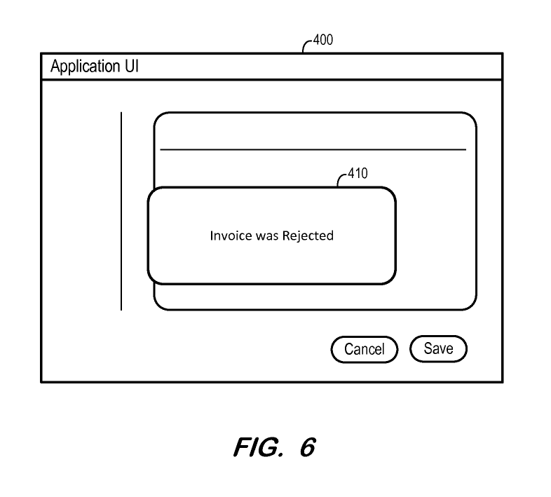

Similarly, and according to some embodiments, reading speed data need not be received from various sources at each iteration of S330. Rather, reading speed data may be periodically received and used to update stored reading speed data for subsequent access at S330. In this regard, FIG. 6 is a tabular representation of a portion of reading speed data 600 according to some embodiments.

Reading speed data 600 may be stored among data 120 or database 210 according to some embodiments. According to one example, an application 235 periodically receives reading speed data from various sources and updates data 600 based thereon. As shown, data 600 includes a column specifying a user, a user age, a reading speed (e.g., represented as words per second) and a number of samples.

Data 600 illustrates an embodiments in which reading speed data is updated in response to received reading speed data samples, but embodiments are not limited thereto. The number of samples associated with a record of data 600 indicates the number of individual reading speed data samples which were used to calculate the reading speed identified in the record. For example, a sample of electronic reader data 515 associated with a user may indicate a reading speed of 6 words/sec and a sample of gaze tracking data 510 associated with the same user may indicate a reading speed of 5 words/sec. These two samples may be used to determine a reading speed specified in a record of data 600 associated with the user. Different weights may be attributed to samples from various sources, and used to calculate a reading speed based on the samples. Additionally or alternatively, a weight of a sample may depend upon a timestamp of the sample, with higher weights being attributed to more-recent samples.

As also illustrated, a record of data 600 may be associated with a demographic group (e.g., 35-45 year olds) rather than with a specific user. The reading speed of such a record may be calculated based on reading speed data samples associated with several members of the demographic group. In the case of a multi-user environment such as that depicted in FIG. 2, received reading speed data associated with a first user may therefore influence the reading speed determined at S330 for a second user.

Returning to process 300, a finite duration for which to display the message is determined at S340 based on the length determined at S320 and the speed determined at S330. For example, if the message is determined to be 15 words long and the reading speed is 5 words/sec, the finite duration is determined to be 3 seconds. Accordingly, the message is displayed for the finite duration at S350. Flow then returns to S310 to await a determination to display another message.

According to some embodiments, S330 and S340 are executed such that a specified proportion of users (e.g., 95%) are expected to be able to read the message within the determined finite duration. For example, the reading speed determined at S330 may be a reading speed of the 5th percentile of users in the relevant group of users. The relevant group may be determined based on any combination of demographic characteristics. If the relevant group consists only of the present user, the reading speed may be determined to be the 5th percentile of all reading speeds which have been stored for the particular user.

The finite duration of message display may additionally or alternatively be determined based on the reading speed and on a confidence level. The confidence level may be determined in direct proportion to the number of samples upon which the determination of reading speed was based. In the case of lower confidence levels, the determination of the finite duration may factor in a larger safety margin. The determinations at S330 and S340 may be assisted by relevant statistical parameters derived from reading time distributions (e.g., averages and standard deviations, or, shape and scale parameters of Weibull distributions).

FIG. 7 illustrates user interface 400 of FIG. 4 and message window 410 displayed at S350 according to some embodiments. Continuing with the above example, message window 410 is displayed for three seconds and then removed (i.e., no longer displayed). As a result, some embodiments may increase user productivity by displaying messages for a user-appropriate time period.

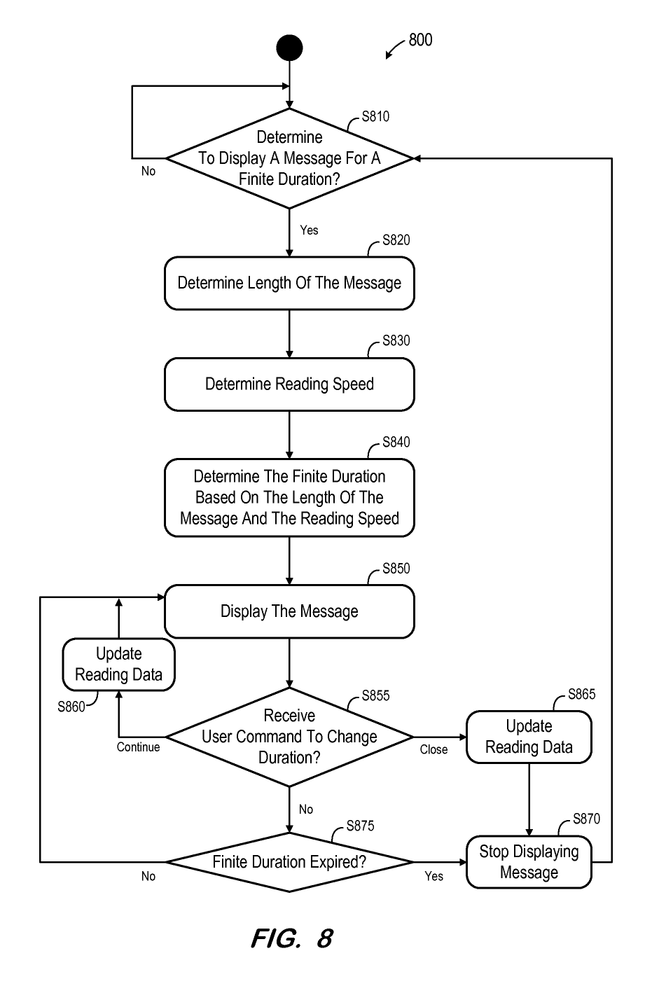

FIG. 8 is a flow diagram of process 800 according to some embodiments. Process 800 provides an example of the use of UI interaction data to adaptively adjust a reading speed associated with a user. Steps S810 through S840 of process 800 proceed as described above with respect to S310 through S340 of process 300. At S850, the message to be displayed is displayed.

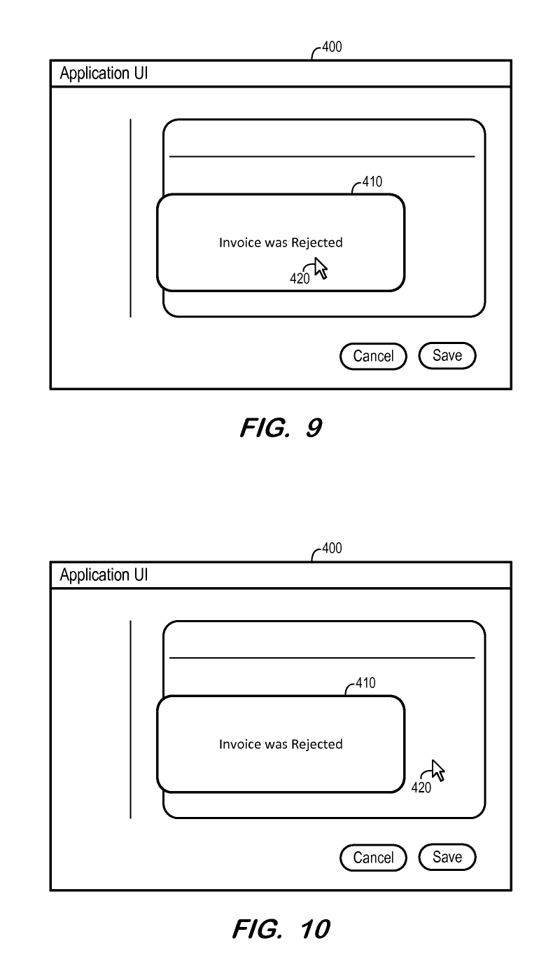

While the message is displayed, it is determined at S855 whether a user command has been received to change the duration for which the message is to be displayed (i.e., the duration determined at S840). FIG. 9 illustrates such a user command according to some embodiments. Specifically, a user has moved cursor 420 to rest upon message window 410. According to the UI paradigm of the present example, this location of cursor 420 is interpreted at S855 as a user command to continue displaying message window 410, regardless of the duration determined at S840. Embodiments may use any other UI interaction to detect this user command.

Flow therefore proceeds from S855 to S860 to update reading speed data. For example, it may be assumed that the user has entered the user command in order to have additional time to read the message, and the reading speed data associated with the user may be updated (e.g., reduced) at S860 to reflect this assumption. Flow returns to S850 and continues to cycle through S850, S855 and S860 so long as the user enters a command to continue display of message window 410. With respect to the present example, flow cycles through S850, S855 and S860 so long as cursor 420 resides upon message window 410.

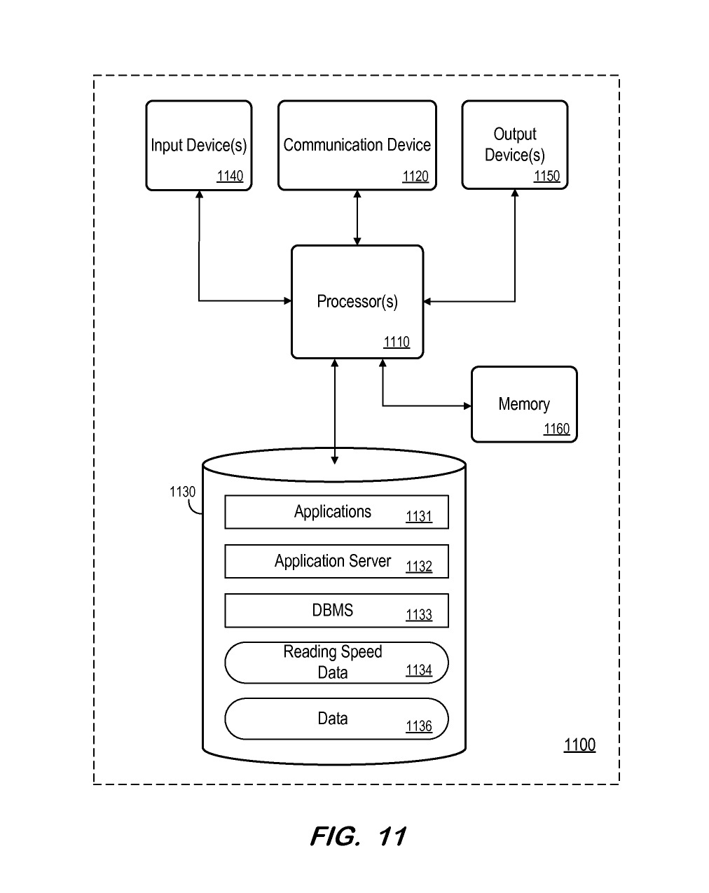

During such cycling, it will now be assumed that the user moves cursor 420 off of window 410 as shown in FIG. 10. Flow therefore proceeds from S855 to S875 to determine whether the finite duration determined at S840 has expired. If not, flow returns to S850 to continue to display the message, and cycles between S850, S855 and S875 until the duration expires, so long as no user commands to change the duration are received in the interim. Once it is determined that the duration has expired at S875, flow proceeds to S870 to stop displaying the message and flow returns to S810.

According to some embodiments, a user command to close the message window may be received during display of the message. For example, returning to FIG. 9, a user may move cursor 420 onto window 410 and execute a mouse click. This gesture may be interpreted in some embodiments as a command to close window 410. Flow therefore proceeds to S865 to update associated reading speed data. For example, it may be assumed that the user has closed window 410 because the user has finished reading the displayed message. The reading speed data associated with the user may therefore be updated (e.g., increased) at S865 to reflect this assumption. Flow then continues to S870 to stop displaying the message. S865 may occur after S870 in some embodiments.

FIG. 11 is a block diagram of apparatus 1100 according to some embodiments. Apparatus 1100 may comprise a general-purpose computing apparatus and may execute program code to perform any of the functions described herein. According to some embodiments, apparatus 1100 may comprise an implementation of display 110 and data 120 of FIG. 1 and/or of application server 230 and database 210 of FIG. 2. Apparatus 1100 may include other unshown elements.

Apparatus 1100 includes processor(s) 1110 operatively coupled to communication device 1120, data storage device 1130, one or more input devices 1140, one or more output devices 1150 and memory 1160. Communication device 1120 may facilitate communication with external devices, such as a client, or an external data storage device. Input device(s) 1140 may comprise, for example, a keyboard, a keypad, a mouse or other pointing device, a microphone, knob or a switch, an infra-red (IR) port, a docking station, a touch screen, and/or gesture-detecting touch-free interfaces. Input device(s) 1140 may be used, for example, to enter information into apparatus 1100. Output device(s) 1150 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, etc., while memory 1160 may comprise Random Access Memory (RAM), Storage Class Memory (SCM) or any other fast-access memory.

Applications 1131, application server 1132 and DBMS 1133 may comprise program code executed by processor(s) 1110 to cause apparatus 1100 to perform any one or more of the processes described herein. Embodiments are not limited to execution of these processes by a single apparatus.

Reading speed data 1134 and data 1136 (either cached or a full database) may be stored in device 1130 as shown and/or in volatile memory such as memory 1160. Data storage device 1130 may also store data and other program code for providing additional functionality and/or which are necessary for operation of apparatus 1100, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a display device;
a memory storing processor-executable process steps; and
a processor to execute the processor-executable process steps to cause the system to:
determine to display a message to a user;
determine a length of the message;
determine a reading speed associated with the user;
determine a finite duration based on the length of the message and the reading speed; and
display the message to the user on the display device for the finite duration.

2. A system according to claim 1, wherein the processor is further to execute the processor-executable process steps to cause the system to:
determine to display a second message to the user;
determine a second length of the second message, the second length different from the first length;
determine a second finite duration based on the second length and the reading speed, the second finite duration different from the first finite duration; and
display the second message to the user on the display device for the second finite duration.

3. A system according to claim 1, wherein the processor is further to execute the processor-executable process steps to cause the system to:
determine to display a second message to a second user;
determine a second length of the second message;
determine a second reading speed associated with the second user, the second reading speed different from the first reading speed;
determine a second finite duration based on the second length and the second reading speed; and
display the second message to the second user on the display device for the second finite duration.

4. A system according to claim 1, wherein the processor is further to execute the processor-executable process steps to cause the system to:
change the reading speed associated with the user;
determine to display a second message to the user;
determine a second length of the second message, the second length different from the first length;
determine a second finite duration based on the second length and the changed reading speed; and
display the second message to the user on the display device for the second finite duration.

5. A system according to claim 4, wherein change of the reading speed comprises:
detect a user interaction with the displayed message; and
change of the reading speed based on the user interaction.

6. A system according to claim 5, wherein detection of the user interaction with the displayed message comprises:
detection of a user command to close a window displaying the message.

7. A system according to claim 5, wherein detection of the user interaction with the displayed message comprises:
detection of a user command to continue to display the window displaying the message.

8. A computer-implemented method comprising:
determining to display a message to a user;
determining a length of the message;
determining a reading speed associated with the user;
determining a finite duration based on the length of the message and the reading speed; and
displaying the message to the user on the display device for the finite duration.

9. A method according to claim 8, further comprising:
determine to display a second message to the user;
determine a second length of the second message, the second length different from the first length;
determine a second finite duration based on the second length and the reading speed, the second finite duration different from the first finite duration; and
display the second message to the user on the display device for the second finite duration.

10. A method according to claim 8, further comprising:
determine to display a second message to a second user;
determine a second length of the second message;
determine a second reading speed associated with the second user, the second reading speed different from the first reading speed;
determine a second finite duration based on the second length and the second reading speed; and
display the second message to the second user on the display device for the second finite duration.

11. A method according to claim 8, further comprising:
change the reading speed associated with the user;
determine to display a second message to the user;
determine a second length of the second message, the second length different from the first length;
determine a second finite duration based on the second length and the changed reading speed; and
display the second message to the user on the display device for the second finite duration.

12. A method according to claim 11, wherein changing the reading speed comprises:
detecting a user interaction with the displayed message; and
changing of the reading speed based on the user interaction.

13. A method according to claim 11, wherein detecting the user interaction with the displayed message comprises:
detecting a user command to close a window displaying the message.

14. A method according to claim 11, wherein detecting the user interaction with the displayed message comprises:
detecting a user command to continue to display the window displaying the message.

15. A non-transitory computer-readable medium storing program code, the program code executable by a computer system to cause the computer system to:
determine to display a message to a user;
determine a length of the message;
determine a reading speed associated with the user;
determine a finite duration based on the length of the message and the reading speed; and
display the message to the user on the display device for the finite duration.

16. A medium according to claim 15, the program code further executable by the computer system to cause the computer system to:
determine to display a second message to the user;
determine a second length of the second message, the second length different from the first length;
determine a second finite duration based on the second length and the reading speed, the second finite duration different from the first finite duration; and
display the second message to the user on the display device for the second finite duration.

17. A medium according to claim 15, the program code further executable by the computer system to cause the computer system to:
determine to display a second message to a second user;
determine a second length of the second message;
determine a second reading speed associated with the second user, the second reading speed different from the first reading speed;
determine a second finite duration based on the second length and the second reading speed; and
display the second message to the second user on the display device for the second finite duration.

18. A medium according to claim 15, the program code further executable by the computer system to cause the computer system to:
change the reading speed associated with the user;
determine to display a second message to the user;
determine a second length of the second message, the second length different from the first length;
determine a second finite duration based on the second length and the changed reading speed; and
display the second message to the user on the display device for the second finite duration.

19. A medium according to claim 18, wherein change of the reading speed comprises:
detect a user interaction with the displayed message; and
change of the reading speed based on the user interaction.

20. A medium according to claim 19, wherein detection of the user interaction with the displayed message comprises:
detection of a user command to close a window displaying the message; or
detection of a user command to continue to display the window displaying the message.
